(19) United States
(12) Patent Application Publication
(10) Pub. No.: US 2002/0049064 A1
(43) Pub. Date: Apr. 25, 2002

(54) Mobile telephone, mobile telephone system, and base station used therein

(75) Inventor: Satoshi Banno, Tokyo (JP)

Correspondence Address: SUGHRUE, MION, ZINN, MACPEAK & SEAS, PLLC, 2100 Pennsylvania Avenue, N.W., Washington, DC, 20037-3202, US

(73) Assignee: NEC CORPORATION

(21) Appl. No.: 09/982,817

(22) Filed: Oct. 22, 2001

(30) Foreign Application Priority Data
Oct. 24, 2000 (JP) 2000-324261

(51) Int. Cl. H04Q 7/20

(52) U.S. Cl. 455/456; 455/457

(57) ABSTRACT

A mobile telephone has a first acquisition means, which acquires position information of a base station having a stored position, a second acquisition means, which acquires position information for a current position, a calculation means, which, based on the position information acquired by the first acquisition means and the second acquisition means and position information input for the target position, calculates an angle formed between a line joining the current position and the base station and a line joining the current position and the target position, a first locating means, which, based on a received level of a signal transmitted from the base station, locates a direction to a location of the base station, and a second locating means, which, based on the direction located by the first locating means and the angle calculated by the calculation means, locates a direction to the target position.

### BACKGROUND OF THE INVENTION

1. Field of the Invention

The present invention relates to a mobile telephone, to a mobile telephone system, and to a base station used therein, and more particularly it relates to a mobile telephone, a mobile telephone system, and a base station used therein, whereby a direction to a target position is identified by using position information of a base station.

2. Related Art

In the past, with a known mobile telephone, such as a cellular phone or micro-cell cellular phone, such as PHS (e.g., a Personal Handyphone System device) when the longitude and latitude or the like of a target are input to the mobile telephone by a user, the direction to the target is identified, and the results of this identification are indicated on a display.

Such mobile telephones as noted above have an input means for inputting position information of a target, a position measuring means using a system such as the Global Position System (hereinafter called as GPS) or the like, a storage section for storing the measurement results of the position measuring means, a direction location means for locating the direction of the target, based on past measurement results stored in the storage section and newly measured results measured by the position measuring means, after the position of the mobile telephone has moved, and a display for indicating the direction to a specified target position.

First, when position information of a target is input through the input means, based on a GPS signal transmitted from a GPS satellite, position information of the current position of the mobile telephone is measured, and these measurement results are stored in the storage section. Then, when the mobile telephone subsequently moves, the position information for the mobile telephone is again measured, based on a GPS signal transmitted from a GPS satellite.

Next, the location means locates the direction to the target position, based on the measurement results measured after movement of the mobile telephone, the measurement results stored in the storage section for the mobile telephone position before being moved, the position information of the target, and the direction of movement of the mobile telephone. The direction located as the direction to the target position is indicated in this manner on the display.

With conventional technology, however, in order to calculate the direction to the target position, the position information for the mobile telephone before and after movement and the position information of the target are used. Thus, unless the mobile telephone moves, it was not possible to locate the direction to the target position. For this reason, there was a particularly inconvenience created by the lack of ability to locate the direction to a target position when riding in a vehicle caught in congested traffic.

Accordingly, it is an object of the present invention to provide a mobile telephone that can locate the direction to a target position without the need to move the mobile telephone.

### SUMMARY OF THE INVENTION

In order to achieve the above-noted objects, the mobile telephone of the present invention has a first acquisition means, which acquires position information of a base station having a stored position, a second acquisition means, which acquires position information of the telephone for the current position, a calculation means, which, based on the position information acquired by the first and second acquisition means and the position information input for the target position, calculates the angle formed between a line joining the current position and a base station and a line joining the current position and the target position, a first locating means, which, based on a received level of a signal transmitted from the base station, locates the direction to the location of the base station, and a second locating means, which, based on the direction located by the first locating means and the angle calculated by the calculation means, locates the direction to the target position.

A mobile telephone system according to the present invention has the above-noted mobile telephone and a base station which transmitting its own position information to the mobile telephone.

Additionally, a base station according to the present invention is used in the above-noted mobile telephone system, and transmits its own position information to the mobile, telephone in response to a request from the mobile telephone.

### BRIEF DESCRIPTION OF THE DRAWINGS

FIG. 1 is a block diagram showing the configuration of a mobile telephone according to an embodiment of the present invention.

FIG. 2 is a block diagram showing the internal configuration of a directional antenna and a demodulator.

FIG. 3 is a drawing showing the relationship between the directional antenna and the display.

FIG. 4 is a drawing showing the condition in which the direction to the target position is indicated on the display using the directional antenna shown in FIG. 3.

FIG. 5 is a flowchart showing the operation of the mobile telephone shown in FIG. 1.

### DETAILED DESCRIPTION OF THE PREFERRED EMBODIMENTS

Embodiments of the present invention are described in detail below, with references made to relevant accompanying drawings.

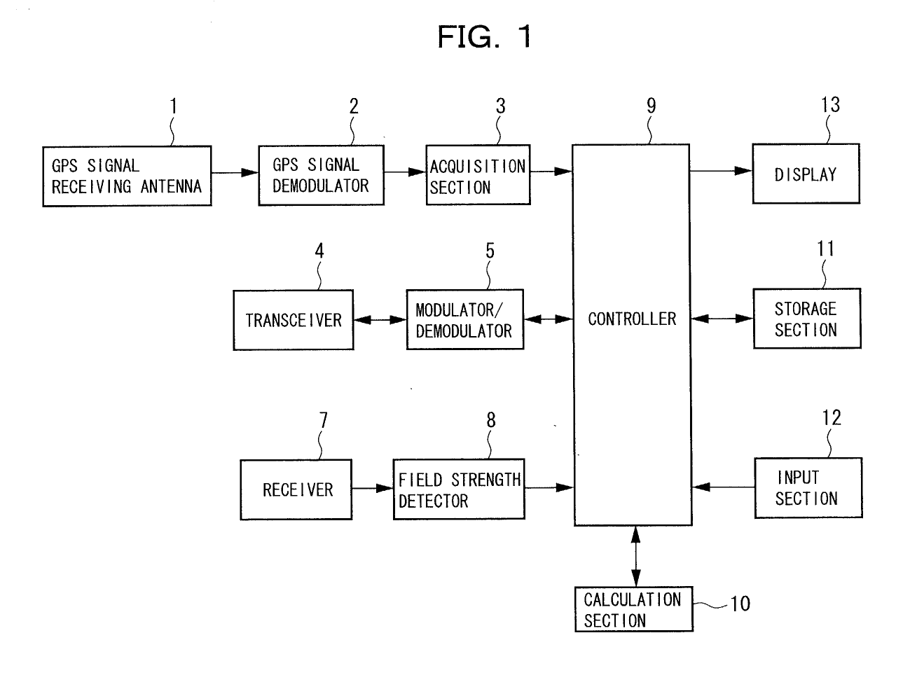

Specifically, FIG. 1 is a block diagram showing the configuration of a mobile telephone according to an embodiment of the present invention. FIG. 1 shows a GPS signal receiving antenna 1, which receives a GPS signal transmitted from a plurality of GPS satellites, a GPS signal demodulator 2, which demodulates each GPS signal received by the GPS signal receiving antenna 1, and an acquisition section 3, serving as a second acquisition means, which, based on each GPS signal demodulated by the GPS signal demodulator 2, performs processing so as to calculate the current position of the mobile telephone.

FIG. 1 also shows a transceiver 4 having an omni-directional antenna, which performs transmission and receiving of various signals such as audio signals, character signals, and images and the like, with a base station having a registered position, and a modulator/demodulator 5, which performs modulation of various signals transmitted to a base station via the transceiver 4 and demodulation of various signals transmitted from the transceiver 4.

FIG. 1 further shows a receiver 7 having a directional antenna for locating the direction of a base station position by receiving various signals transmitted from a base station, and performing selection of a specified frequency from a received signal, so as to perform noise elimination or the like, and a field strength detector 8 serving as the first locating means, which detects the field strength of a signal received from the receiver 7.

FIG. 1 further shows an input section 12, which inputs position information of a target position, a storage section 11, into which is stored such information as position information with regard to a target input by the input section 12, position information with regard to the current position acquired by the acquisition section 3, position information with regard to the base station extracted from a received signal demodulated by the modulator/demodulator 5, and a direction information to a position of a base station located based on a field strength detected by the field strength detector 8, a calculation section 10, which, based on various information priory stored in the storage section 11, calculates the direction to a target position, thereby serving as a calculation means and a second location means, and a controller 9, which serves as a first acquisition means, which performs control of the processing operations of the above-noted elements.

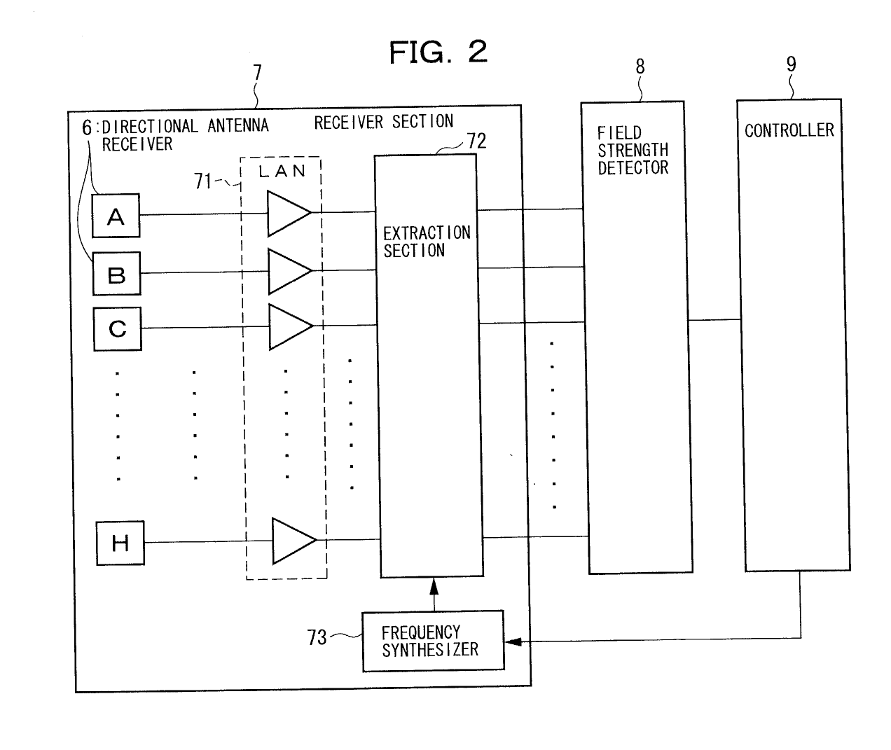

FIG. 2 is a block diagram showing the internal configuration of the receiver 7 shown in FIG. 1. The receiver 7 has, for example, a directional antenna 6, which locates the eight directions A through H, a low-noise amplifier (LNA) 71, which reduces the noise on various signals from the base station output from the directional antenna 6, an extraction section 72 for the purpose of extracting a signal of a specified channel (received frequency) from the reduced-noise signals, and a frequency synthesizer 73 for the purpose of establishing the channel to be extracted (received frequency).

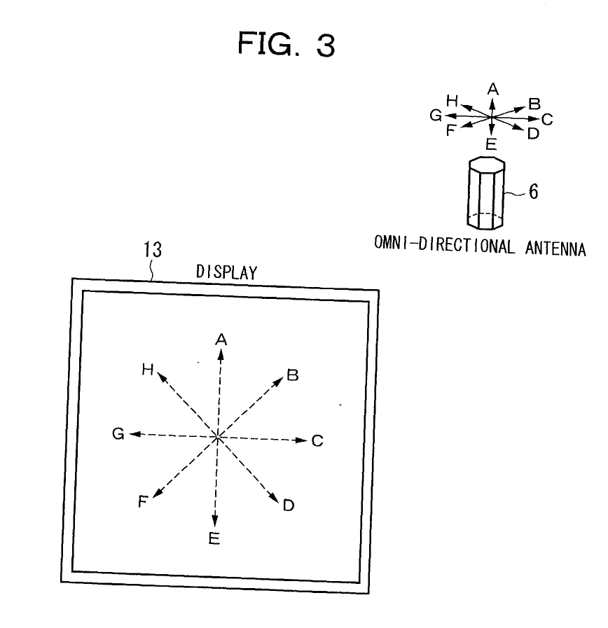

FIG. 3 is a drawing showing the relationship between the directional antenna 6 and a display 13 of FIG. 1. As noted above, the directional antenna 6 is set up to be able to locate the eight directions A through H, and the display 13 is made so as to be able to indicate the 8 directions A through H by means of arrows.

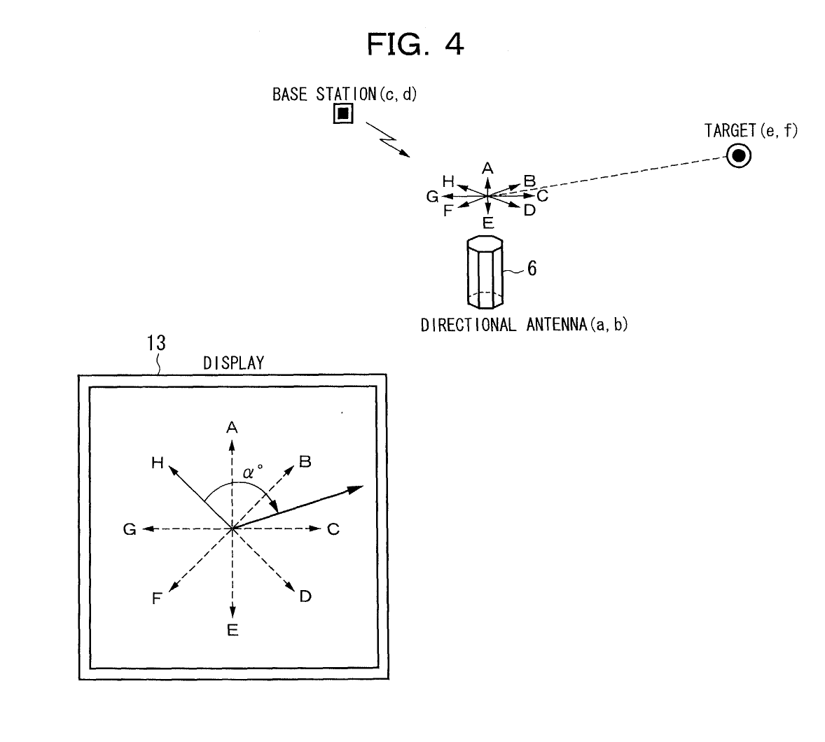

FIG. 4 is a drawing showing the condition in which the direction toward a target is indicated on the display 13 using the directional antenna 6. In this case, latitude and longitude are used as the position information, the latitude and longitude of the mobile telephone being (a, b), the latitude and longitude of the base station being (c, d), and the latitude and longitude of the target position being (e, f). A base station exists in the H direction, and a target position exists between the B and C directions. An angle of α is formed between a line joining the current position and the base station and a line joining the current position and the target position.

When various signals are received from the base station using the directional antenna 6, it is possible, based on the field strength of the various signals, to locate the direction of the base station with respect to the mobile telephone as being the H direction. When communications is established between the mobile telephone and the base station, for example, the mobile telephone uses the transceiver 4 and the modulator/demodulator 5 to acquire the latitude and longitude of the base station as being (c, d), and further uses the GPS signal receiving antenna 1, the GPS signal demodulator 2, and the acquisition section 3 to acquire the latitude and longitude of the mobile telephone itself as being (a, b).

Because based on the latitude and longitude (a, b) of the mobile telephone, the latitude and longitude (c, d) of the base station, and the latitude and longitude (e, f) of the target, it is possible to calculate the angle a, the direction toward the position of the target from the current position is located with reference to the a line joining the current position and the base station.

The base station has a transmitting means for transmitting to the mobile telephone its own position information, in response to a request from the mobile telephone.

The operation of an embodiment of the present invention is described below.

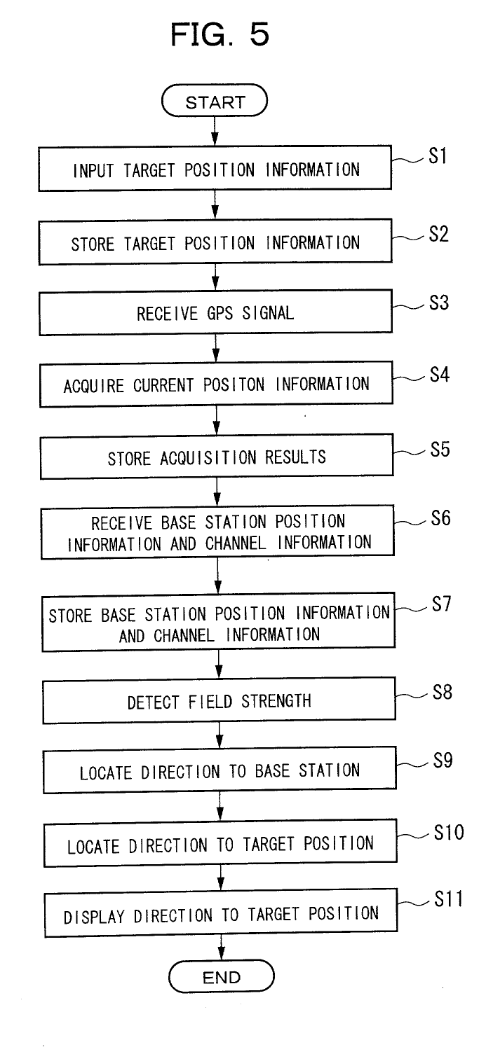

FIG. 5 is a flowchart illustrating the operation of the mobile telephone shown in FIG. 1. The operation of a mobile telephone according to the present invention is described herein for the case in which the mobile telephone, the base station and the target position are positional related as shown in FIG. 4.

First, target position information is input by the user from the input section 12, this position information being the latitude and longitude (e, f) (step S1). This position information is output to the controller 9, which stores the output position information into the storage section 11 (step S2).

Next, in order to acquire the current position information, the GPS signal receiving antenna 1 receives GPS signals transmitted from at least three GPS satellites (step S3) and outputs these to the GPS signal demodulator 2, which demodulates the output GPS signals, and then outputs them to the acquisition section 3.

The acquisition section 3, by calculating each of the output GPS signals, acquires the latitude and longitude (a, b) of the current position of the mobile telephone (step S4), and outputs the acquisition result to the controller 9, which stores the output acquisition result into the storage section 11 (step S5).

Next, in order to acquire the position information for a base station with which communication is currently established, the controller 9 generates a request signal with respect to the base station, and outputs this request signal to the modulator/demodulator 5, which modulates the output request signal, and then outputs the signal to the transceiver 4. The transceiver 4, uses an omni-directional antenna to transmit the request signal to the base station.

When the base station receives the request signal transmitted from the mobile telephone, it transmits to the mobile telephone various signals, to which have been appended its own characteristically assigned position information, via a control channel.

The mobile telephone receives the various transmitted signals using the transceiver 4 and the receiver 7(step S6). The various signals received by the transceiver 4 are output to the modulator/demodulator 5, which demodulates the various output signals, and then outputs the signals to the controller 9. From the various output signals, the controller 9 determines the latitude and longitude of the base station is (c, d) and extracts channel information (received frequency) for the channel on which communication is current established, and then stores these in the storage section 11 (step S7).

After the above, the controller 9 reads out the channel information stored in the storage section 11, and controls the frequency synthesizer 73 so that only the signal of this channel (frequency) is sent to the field strength detector 8.

At the receiver 7, the various received signals are reduced in noise by the low-noise amplifier 71, and sent to the extraction section 72. The frequency synthesizer 73 cause the extraction section 72 to extract a signal of the channel to be used for output to the field strength detector 8, and causes this output to the field strength detector 8.

The field strength detector 8, based on the amplitude of the received signal corresponding to each directional antenna 6, detects the field strength (step S8). The detection results are output to the controller 9 by determining that the base station is located at the position of a directional antenna having the maximum field strength. In this case, the location of the base station position is taken to be in the direction of the H directional antenna 6, and information to this effect is output to the controller 9.

The controller 9 first stores the output location results as base station direction information into the storage section 11, after which the target position information, position information of the base station, the current position information, and the base station direction information are read out of the storage section and output to the calculation section 10, which, based on the various output information, locates the direction to the target position relative to the current position (step S10), and outputs the location results to the controller 9.

More specifically, the difference is taken between the latitude and longitude (a, b) of the current position of the mobile telephone and the latitude and longitude (c, d) of the base station, and the direction (a-c, b-d) is determined as the direction H. Next, based on the current position, base station position, and target position, the angle a formed between a line joining the current position and the base station and a line joining the current position and the target is determined. Then, the direction rotated by the angle of a degrees relative to the H direction, which is the line joining the current position and the base station, is taken as the direction to the target position.

By displaying the output location results on the display 13, the controller 9 notifies the user in a visible manner (step S11).

While the foregoing embodiment is described for the case in which the display 13 indicates the direction to the target position, it will be understood that the present invention is not restricted in this manner, and that it is alternatively possible to take the difference between the latitude and longitude (a, b) of the current position and the latitude and longitude (e, f) of the target, to further calculate the distance from the current position to the target, and to display this distance on the display 13 together with the direction to the target. Additionally, it is alternatively possible to access an Internet website providing a map of an area that encompasses the current position and the target, and to cause the display of the provided map on the display 13, this serving as a guide to a path leading from the current position to the target.

In the present invention, as described in detail above, the angle formed by a line joining the current position and the base station and a line joining the current position and the target is calculated, based on the acquired base station position information and current position information, and on the input target position information, and the direction to the position of the base station is located based on the received level of a signal transmitted from the base station, the location results being used as the basis for locating the target position, thereby enabling location of the target position, even in the case in which the mobile telephone is not moved.

What is claimed is:

1. A mobile telephone comprising:
a first acquisition means, which acquires position information of a base station having a stored position;
a second acquisition means, which acquires position information for a current position;
a calculation means, which, based on said position information acquired by said first acquisition means and said second acquisition means and position information input for the target position, calculates an angle formed between a line joining said current position and said base station and a line joining said current position and said target position;
a first locating means, which, based on a received level of a signal transmitted from said base station, locates a direction to a location of said base station; and
a second locating means, which, based on said direction located by said first locating means and said angle calculated by said calculation means, locates a direction to said target position.

2. A mobile telephone according to claim 1, wherein a direction to said target located by said second locating means is caused to be indicated on a display.

3. A mobile telephone according to claim 1, wherein said first locating means comprises:
a directional antenna receiving a signal transmitted from said base station; and
a calculation means calculating a field strength of said received signal, wherein,
said first locating means determines a calculated direction having a maximum field strength as a direction to a position of said base station.

4. A mobile telephone according to claim 1, wherein said second acquisition means acquires position information of said current position, based on signals sent from a plurality of GPS satellites.

5. A mobile telephone system comprising:
a mobile telephone according to any one of claim 1 to claim 4; and
a base station transmitting its own position information to said mobile telephone.

6. A base station used in a mobile telephone system according to claim 5, which transmits its own position information in response to a request from said mobile telephone.
